(19) United States
(12) Patent Application Publication
(10) Pub. No.: US 2017/0178468 A1
(43) Pub. Date: Jun. 22, 2017

(54) Notification Device

(71) Applicant: Twinkle ApS, Copenhagen (DK)

(72) Inventor: Robert Gauti Jonsson, Copenhagen (DK)

(21) Appl. No.: 15/447,744

(22) Filed: Mar. 2, 2017

Related U.S. Application Data
(63) Continuation of application No. PCT/DK2015/050264, filed on Sep. 4, 2015.

(51) Int. Cl. G08B 5/36; G06F 1/16; A44C 5/00; A44C 15/00; H04B 1/3827; H04M 1/725

(52) U.S. Cl. CPC G08B 5/36; H04B 1/385; H04M 1/7253; A44C 5/0015; A44C 15/0015; G06F 1/163

(57) ABSTRACT

A notification device is disclosed. The notification device comprises a communication unit configured to wirelessly communicate with a master unit. The notification device comprises one or more signalling members and/or insert members configured to provide a signal upon receiving a signal from a master unit. The notification device comprises a plurality of different signalling members and/or insert members each allocated to signal when the master unit, receives signals from different predefined individuals and/or group(s).

### FIELD OF INVENTION

The present invention generally relates to a communication device that a user can wear or bring along. The present invention more particularly relates to a communication device that is capable of signalling when an individual, group or authority is providing a communicative indication.

### PRIOR ART

Today, the use of smartphones and social media including groups of Internet-based applications for communication purposes has increased to a high level. Notifications and messages sent to a receiving individual from a sending individual or group has become a natural ingredient of many individuals everyday life.

Thus, there is an increasing awareness of devices that are capable of supplementing smartphones and Internet-based applications.

U.S. 20090181726 discloses a notification device configured to be used with a wireless communication device such as a mobile phone. The notification device comprises one device adapted to generate event and preference based alerts for informing the user. The notification device is, however, required to be rather complex (and thus expensive) in order to be capable of presenting information sufficiently unique to indicate the origin of the event and preference.

Thus, in order to reduce the cost, there is a need for an alternative notification device that is capable of indicating the origin of a notification in an easy detectable manner by simpler means than the prior art notification devices.

Accordingly, it is an object of the present invention to provide a notification device that is capable of indicating the origin of a notification in an easily detectable manner by using simpler means than the prior art notification devices.

It is further an object of the present invention to provide a notification device that is capable of notifying the user about the origin of several incoming communications at the same time.

Besides, it is an object of the present invention to provide a notification device that is capable of being individually designed.

### SUMMARY OF THE INVENTION

The object of the present invention can be achieved by a notification device as defined in claim 1. Preferred embodiments are defined in the dependent sub claims, explained in the following description and illustrated in the accompanying drawings.

The notification device according to the invention is a notification device comprising a communication unit configured to wirelessly communicate with a master unit, which notification device comprises one or more signalling members and/or insert members configured to provide a signal upon receiving a signal from a master unit. The notification device comprises a plurality of different signalling members and/or insert members arranged at a plurality of different positions on the notification device, and a communication unit configured to generate a unique and predefined position specific signal for each predefined individuals and/or group(s) when the master unit receives signals from one or more different predefined individuals and/or group(s).

Hereby it is possible to provide an improved notification device that is capable of indicating the origin of a notification in an easily detectable manner without reading a message. The user of the notification device will be able to identify the origin of a notification in a simple and fast manner by means of the generated, unique, position specific and predefined signal.

The term “group” refers to several individuals constituting an organisation, a music band, a brand or another collection of individuals acting as one group.

In one embodiment of the invention, a first signal mode is applied for identification of individuals, wherein another signal mode is applied for identification of groups. By way of example, the first mode may apply light emitting signalling members and/or insert members (lighting up with a constant light intensity), whereas blinking signalling members and/or insert members may be applied to identify groups in a second mode.

Hereby, it is possible to individually adapt the notification device and change configuration in order to make it easier to identify the origin of notifications in an easily detectable manner by means of the signalling members and/or insert members. Accordingly, the notification device is configured to provide visual information (and optionally a vibration signal) indicative of the origin of notifications in a fast and user-friendly way by simple means and without the need of reading a message.

By applying a plurality of signalling members and/or insert members provided in different positions of the notification device, it is possible to use signalling members and/or insert members that are simple. The user of the notification device can in a fast and easy manner identify the origin of a notification in a simple and fast manner, since the position of the signalling members and/or insert members is easy to memorise and to recognise for the user.

The signalling members and/or insert members may be configured to light in different colours in a constant intensity mode or in a “blinking” mode, to vibrate (by means of a vibration motor). Thus, since the signalling members and/or insert members have different positions on the notification device, one can use: the position, the colour, the light intensity (constant or blinking) and the vibration signal to define and identify the origin of different individuals and groups.

The notification device comprises a communication unit configured to wirelessly communicate with a master unit.

The communication unit may comprise any suitable receiving means configured to apply any suitable communication protocol e.g. Bluetooth.

The one or more signalling members and/or insert members may be of any suitable type and size. They are configured to provide a signal upon receiving a signal from a master unit. The signal may be a visual signal (e.g. light), an audio signal (e.g. a sound), vibration or a combination of these signals.

The notification device comprises a plurality of different signalling members and/or insert members arranged at a plurality of different positions on the notification device and means (a communication unit) configured to generate a unique and predefined position specific signal for each predefined individuals and/or groups when the master unit receives one or more signals from different predefined individuals and/or groups.

The master unit may be a smart phone. The individuals and/or groups may be friends, connections or groups comprising friends or connections e.g. friends or connections on a social media.

It may be beneficial that the notification device comprises a plurality of different signalling members and/or insert members each allocated to signal when the master unit receives signals from different predefined individuals and/or groups.

This provides an easy and simple way of providing a signal that can identify the identity of the sender.

The signal received by the master unit from different predefined individuals and/or groups may be a notification such as a “twinkle”.

A “twinkle” may be defined as a nice way for someone to say “hello”, in case you have similar interests, live in the same area (city) or have similar backgrounds (friends, a girlfriend, a boyfriend, family, a brand or an artist).

It may be an advantage that the communication unit is configured to generate unique and predefined position specific signals for several predefined individuals and/or group(s) simultaneously, when the master unit simultaneously receives several signals from several different predefined individuals and/or group(s).

Hereby, the notification device is capable of identifying the origin of several notifications simultaneously in a simple and fast manner by means of the generated, unique, position specific and predefined signals. By way of example, a notification device may at the same time show that a twinkle has been received from a friend and from a group.

For instance, two different individuals may twinkle to a user at the same time. The notification device may apply a first charm to indicate an incoming twinkle from the first individual. At the same time, the notification device may apply a second charm to indicate an incoming twinkle from the second individual. Accordingly, the user of the notification device is notified about the two twinkles at the same time.

It may be an advantage that the insert members and/or signalling members are detachably attached to the notification device.

Hereby it is possible to design the notification device in an individual manner. Further, it is possible to change the design of the notification device individually. Accordingly, the notification device may be designed with great design freedom and the design may be altered if and when desired.

It may be beneficial that the insert members and/or signalling members are movably attached to the notification device.

Hereby it is possible to redesign the notification device if desired. Besides, it is possible to change the design of the notification device if preferred. Thus, the notification device can be designed with huge design freedom, and the design may be altered if and when desired.

It may be advantageous that one of the signalling members and/or the insert members is configured to signal upon receiving a receiving signal from any predefined sender and that a plurality of the remaining insert members and/or signalling members are configured to signal only upon receiving a predefined receiving signal from one or more specific and predefined senders.

In this manner, one of the signalling members and/or the insert members will indicate whenever a signal is received. Further, the plurality of the remaining insert members and/or signalling members will indicate when a predefined individual or group is signalling. The signal may be considered as twinkling.

It may be an advantage that the notification device comprises a first member and a second member and that the first member comprises a battery electrically connected to a charging plug member configured to be electrically connected to external charging means.

Hereby it is possible to charge the notification device.

It may be beneficial that the second member comprises a cap configured to be received by the charging plug member.

Accordingly, the cap will protect the charging plug member. Moreover, the cap may comprise one or more electrical components such as a processor, a LED or a button.

It may be an advantage that the second member comprises an insert member configured to signal when a signal (by any sender) is received by the notification device.

The charging plug member may be a Universal Serial Bus (USB) plug. The first member may comprise a plurality of (e.g. four) insert members configured to signal (light up) when a predefined individual or group sends a signal to the notification device.

It may be beneficial that the notification device is a bracelet.

Hereby it is possible for a user to wear the notification device at the wrist and thus to apply the notification device as a piece of jewellery.

It may be advantageous that the notification device comprises means for sending a signal to a master unit and/or to an external receiver (e.g. a smart phone).

The means for sending a signal to a master unit and/or to an external receiver may include a knob member that automatically initiates the sending of a notification back to the individual and/or group from whom the last notification is received.

The notification device comprises means for sending a signal to a smart phone of the individual and/or group from whom the last notification is received.

The means for sending a signal to a master unit and/or to an external receiver may include a transmitter unit configured to transmit a signal by any suitable protocol and wireless technology (e.g. Bluetooth).

The means for sending a signal to a master unit and/or to an external receiver may include a communication unit comprising a processor and a transmitter unit.

It may be an advantage to apply a system comprising a notification device according to the invention and an electrical device (e.g. a server) comprising storage means configured to store one or more software applications and means for being accessed with a sending device (e.g. a smartphone) and means for generating a signal upon receiving a signal from the sending device (e.g. a smartphone), where the signal is receivable by the master unit.

Hereby it is possible to provide a system that makes it possible to individually adjust how the notification device should signal upon receiving signals. Moreover it is possible to provide a system that is easy accessible and controllable.

It may be an advantage that the system comprises a master device configured to communicate with the notification device and to receive a signal from an external device.

Hereby it is possible to apply a notification device that communicates by means of a low energy protocol and that does not need to be able to have a Global System for Mobile Communications module (GSM module) in order to communicate in the desired manner.

It may be beneficial that the system comprises means for defining and changing which of the different signalling members and/or insert members that are allocated to the signal when the master unit receives signals from specific different predefined individuals and/or groups. The means for setting which of the different signalling members and/or insert members that are allocated to the signal when the master unit receives signals from? specific different predefined individuals and/or groups may be any suitable setting member.

Hereby it is possible to individually set the notification device.

The notification device according to the invention is configured to comprise several signalling members and/or insert members that may be formed as charms. The notification device that may be formed as a bracelet makes it possible to place/add different signalling members and/or insert members (e.g. charms) that are part of that unique signal that indicates if an individual (e.g. a friend) or a group of individuals (e.g. a group of friends) are “thinking” of the user. This means that it is both possible to allocate single individuals and/or several individuals constituting one or more groups on the notification device. The friend or group of friends are connected to a specific charm and a specific location on different signalling members and/or insert members (e.g. charms) on the notification device.

Further, a combination of a least one signalling member and/or insert member (e.g. one or more charms) can also indicate if an artist (e.g. a musician) or a brand has shared some content with the user of the notification device. The user is informed due to the fact that the artist/brand is linked to a specific combination of one or more signalling members and/or insert members (e.g. one or more charms) and their specific position on the notification device.

The user may buy new signalling members and/or insert members and change/replace the old ones.

It is possible to apply a mobile application capable of controlling the notification device. By using the mobile application, it is possible to “send thoughts” to other friends, relations or groups and identify the prior activity of corresponding signalling members and/or insert members.

In a preferred embodiment, the notification device is capable of “twinkle back” to the “sender” (the origin of a notification) by activating a activation member (e.g. pressing a button) provided on the notification device.

In one embodiment of the invention, the notification device comprises an activation unit configured to generate and send a GPS signal from the notification device. The activation unit may be activated by pressing/holding an activation button for several seconds by way of example.

The method according to the invention is a method for informing a user of incoming notifications by means of a notification device comprising a communication unit configured to wirelessly communicate with a master unit, which notification device comprises a plurality of signalling members and/or insert members arranged at a plurality of different positions on the notification device and being configured to provide a signal upon receiving a signal from the master unit, wherein the method comprises the step of generating a unique and predefined position specific signal for each predefined individuals and/or group(s) when the master unit receives signals from one or more different predefined individuals and/or group(s).

Hereby it is possible to notify the user about the origin of a notification in an easily detectable manner without reading a message. The user of the notification device will be able to identify the origin of a notification in a simple and fast manner by means of the generated, unique, position specific and predefined signal.

It may be an advantage that the method comprises the step of generating several unique and predefined position specific signals for several predefined individuals and/or group(s) simultaneously, when the master unit simultaneously receives several signals from several different predefined individuals and/or group(s).

Hereby, the user can be notified about the origin of several simultaneously sent notifications in a simple and fast manner.

It may be beneficial that the method comprises the step of setting which of the different signalling members and/or insert members that are allocated to the signal when the master unit, receives signals for specific different predefined individuals and/or group(s).

Hereby it is possible to individually set the notification device.

### DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1a) shows a perspective view of a notification device according to the invention;

FIG. 1b) shows a view of five insert members (charms) configured to be inserted into the receiving members of the rubber band of the notification device;

FIG. 1c) shows a view of the notification device shown in FIG. 1a) seen from the side;

FIG. 2a) shows a perspective view of a notification device according to the invention;

FIG. 2b) shows a side view of the notification device shown in FIG. 2a).

FIG. 3a) shows a perspective view of a notification device according to the invention;

FIG. 3b) shows a perspective view of the notification device shown in FIG. 3a);

FIG. 4 shows an overview of how a notification device according to the invention may be applied to provide communication between a first individual and a second individual;

FIG. 5 shows another overview of how a notification device according to the invention may be applied to provide communication between a first individual and a second individual;

FIG. 6a) shows how a notification device according to the invention can be used to provide the intended communication;

FIG. 6b) shows how a notification device according to the invention can be used to provide the intended communication;

FIG. 7a) shows how a notification device according to the invention can be used to provide the intended communication;

FIG. 7b) shows how a notification device according to the invention can be used to provide the intended communication;

FIG. 8a) shows a section of a notification device according to the invention;

FIG. 8b) shows the bracelet shown in FIG. 7a) in a state in which the cap of the second member has been detachably attached to the charging plug member 50 of the first member;

FIG. 9 shows an overview of how a notification device according to the invention may be applied to provide communication between a first individual and a group of individuals;

FIG. 10 shows how to change the settings by using the method according to the invention and

FIG. 11a) illustrates a schematic view of a mobile phone 32 and a notification device 2 according to the invention;

FIG. 11b) illustrates a notification device;

FIG. 11c) illustrates the notification device 2 schematically shown in FIG. 11b;

FIG. 11d) illustrates an example in which two different insert members (charms) are allocated to notify the user;

FIG. 11e) illustrates a schematic view of a mobile phone 32 and a notification device 2 according to the invention;

FIG. 11f) illustrates an example in which insert member 4″ is allocated to notify the user;

FIG. 11g) illustrates a notification device;

FIG. 11h) illustrates the notification device 2 schematically shown in FIG. 11g;

### DETAILED DESCRIPTION OF THE INVENTION

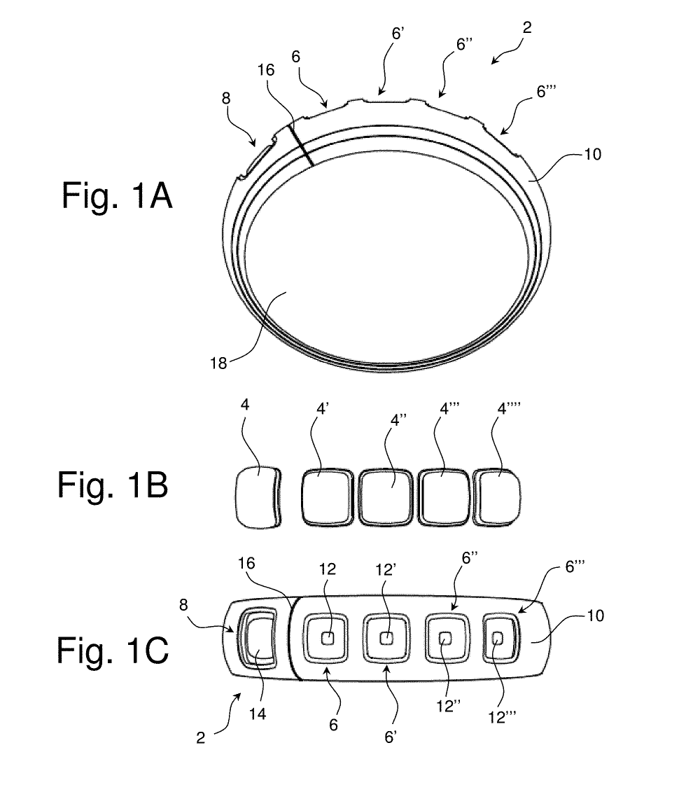

Referring now in detail to the drawings for the purpose of illustrating preferred embodiments of the present invention; different views of a notification device 2 according to the invention are illustrated in FIG. 1.

FIG. 1a) illustrates a perspective view of a notification device 2 according to the invention.

The notification device 2 is formed as a bracelet comprising a rubber band 10 into which a plurality of receiving members 6, 6′, 6″, 6″′, 8 are configured to receive corresponding insert members 4, 4′, 4″, 4″′, 4″″ illustrated in FIG. 1b) below FIG. 1a). A joint 16 is provided in the rubber band 10. By means of the joint 16, it is possible to open and close the rubber band 10.

The bracelet 2 is configured to be worn by a user. The bracelet 2 can be put on by guiding the hand through the opening 18 or by opening the joint 16.

FIG. 1b) illustrates a view of five insert members (charms) 4, 4′, 4″, 4″′, 4″″ configured to be inserted into the receiving members 8, 6, 6′, 6″, 6′″ of the rubber band 10 of the notification device 2.

Each of the different insert members (charms) 4, 4′, 4″, 4″′, 4″″ may be designed individually in order to be able to differentiate between the insert members (charms) 4, 4′, 4″, 4′″, 4″″.

FIG. 1c) illustrates a view of the notification device 2 shown in FIG. 1a) seen from the side.

The notification device 2 comprises one unique receiving member 8 formed as a groove structure adapted to receive and maintain the insert member 4 illustrated in FIG. 1b).

The notification device 2 comprises four additional receiving members 6, 6′, 6″, 6′″ formed as groove structures slightly different from the receiving member 8. The four additional receiving members 6, 6′, 6″, 6″′ are adapted to receive and maintain the corresponding insert members 4, 4′, 4″, 4′″ illustrated in FIG. 1b). The joint 16 explained with reference to FIG. 1a) is provided in the rubber band 10.

The first receiving groove 8 is equipped with a signalling member 14 capable of generating a signal. The signalling member 14 may be a light-emitting diode (LED), and/or a vibrator and/or an audio signal generator.

Likewise the remaining signalling members 12, 12′, 12″, 12′″ may be light-emitting diodes (LED), and/or a vibrators and/or audio signal generators (loudspeakers).

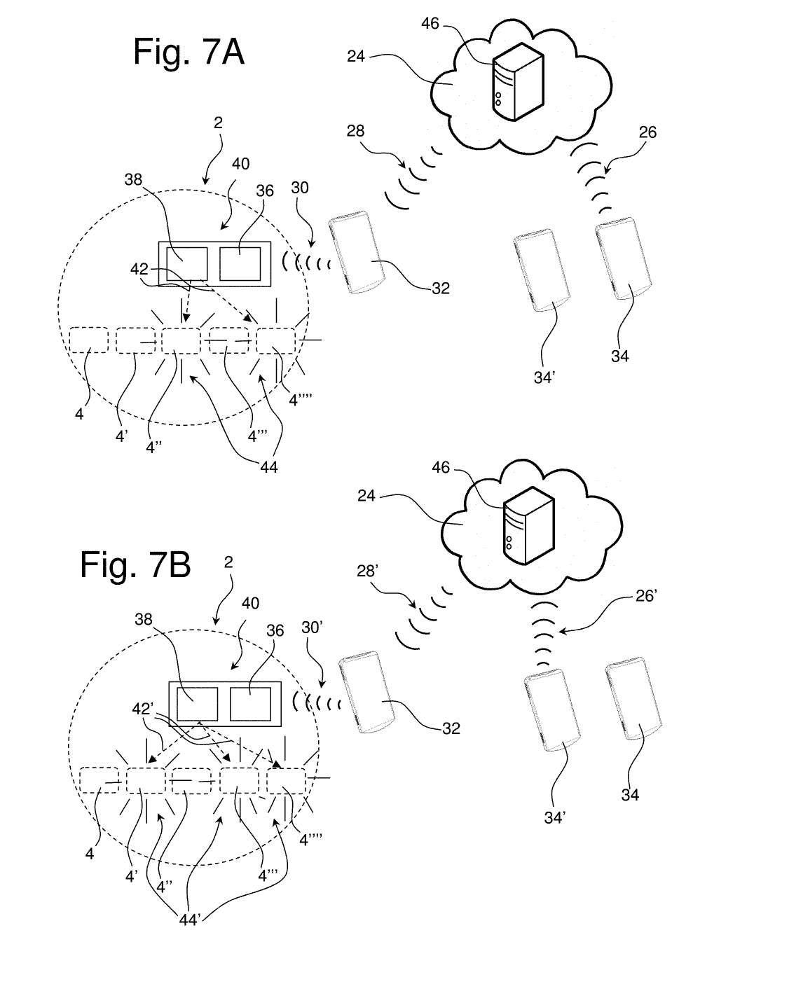

The notification device 2 comprises a removable core unit (see FIG. 7) having a communication unit capable of communicating by any suitable wireless communication technology e.g. a protocol such as Bluetooth. It may be an advantage that the protocol is a low energy protocol such as Bluetooth.

The rubber band 10 may be made of silicone or another resilient material (e.g. an elastomer).

In one preferred embodiment according to the invention, the notification device 2 comprises a removable core unit (see FIG. 7) provided inside the rubber band 10. It may be an advantage that the removable core unit comprises a battery electrically connected to a charging plug member adapted to be received in a Universal Serial Bus (USB) plug. The removable core unit may be an insert charging plug member adapted to be received in a Universal Serial Bus (USB) receiving plug.

The signalling members 12, 12′, 12″, 12′″, 14 may be LED's configured to light up independently upon a signal from a master device such as a smartphone (not shown).

The notification device 2 comprises a processor (not shown) capable of processing an incoming signal causing a predefined signalling member to signal that a specific individual or group has “twinkled” (sent information to the notification device 2) e.g. through an application installed on a master device (e.g. a smartphone).

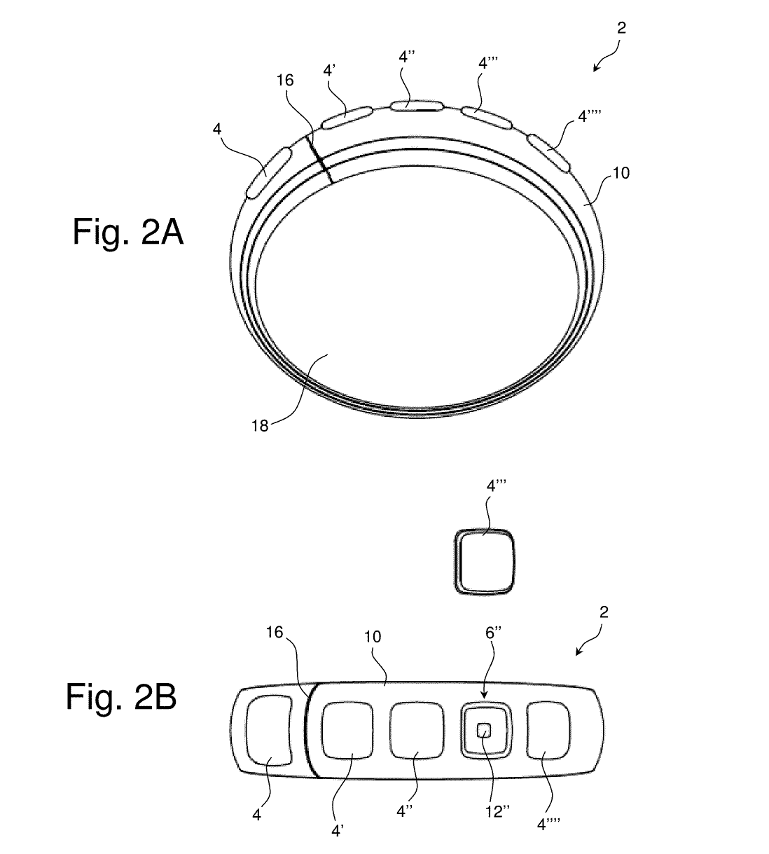

FIG. 2a) illustrates a perspective view of a notification device 2 according to the invention. The notification device 2 corresponds to the one shown in FIG. 1. However, in FIG. 2a), the insert members (charms) 4, 4′, 4″, 4″′, 4″″ have been detachably attached to the rubber band 10 of the notification device 2.

A joint 16 is provided in the rubber band 10. The joint 16 is configured to be used to open and close the rubber band 10. One can put on the bracelet 2 by guiding the hand through the opening 18 or by opening the joint 16.

FIG. 2b) illustrates a side view of the notification device 2 shown in FIG. 2a). One of the insert members (charms) 4′″ has been removed from the rubber band 10 of the notification device 2.

It is possible to replace the insert members (charms) 4″′ with others or to move them to another position within the rubber band 10 of the notification device 2.

The insert members (charms) 4, 4′, 4″, 4″′, 4″″ may comprise a transparent or semi-transparent layer allowing a light signal sent from underlying signalling members (see FIG. 1c) provided as light emitting diodes (LED) to transmit light through the transparent or semi-transparent layer.

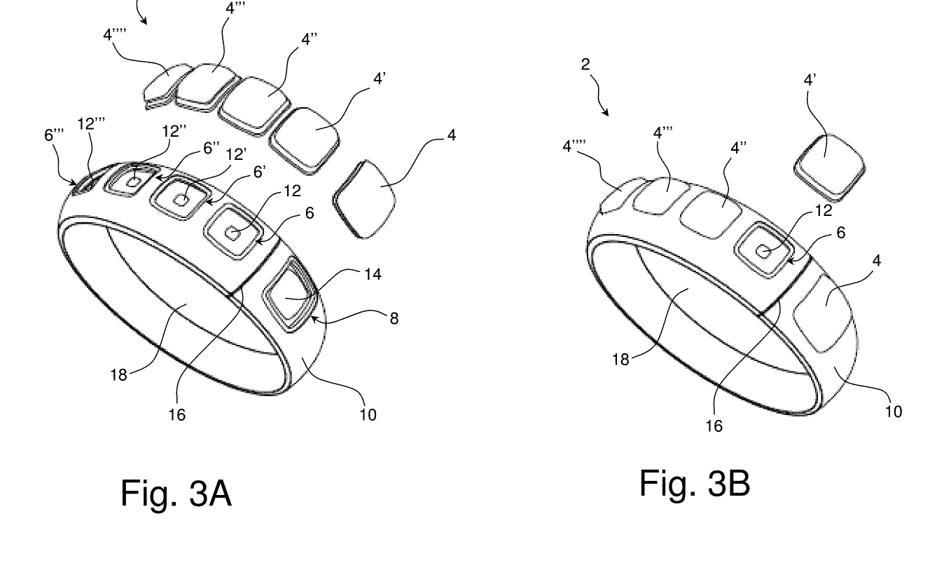

FIG. 3a) illustrates a perspective view of a notification device 2 according to the invention. The notification device 2 is formed as a bracelet having a band 10. A plurality of receiving members 6, 6′, 6″, 6″′, 8 configured to receive corresponding insert members 4, 4′, 4″, 4′″, 4″″ are provided in the band 10. The band 10 is provided with a joint 16 extending axially along the periphery of the band in a manner that makes it possible to open and close the band 10 by means of the joint 16.

The bracelet 2 is adapted to be worn on the wrist of a user. The bracelet 2 can be put on the wrist either through the opening 18 or by opening the joint 16.

FIG. 3b) illustrates a perspective view of the notification device 2 shown in FIG. 3a). The insert members 4, 4″, 4″′, 4″″ have been attached to the corresponding receiving members 6′, 6″, 6″′, 8. The insert member 4′, however, is still not attached to the corresponding receiving member 6.

Accordingly, the insert member 4′ may be detachably attached to the corresponding receiving member 6 or be replaced by another insert member.

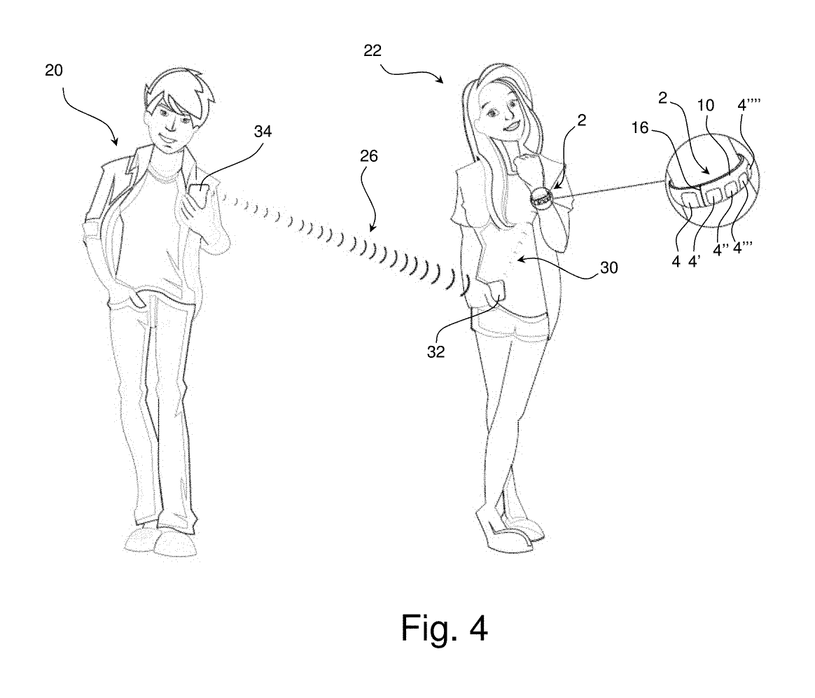

FIG. 4 illustrates an overview of how a notification device 2 according to the invention may be applied to provide communication between a first individual 20 and a second individual 22.

The first individual 20 is a male person that wants to provide the female individual 22 with information that he is thinking about her. The first individual 20 “twinkles” to the second female individual 22.

The communication process is initiated by means of a first smartphone 34 (sending device) that sends a wireless signal 26 to a second smartphone 32 (master device). Upon receiving the wireless signal 26, the second smartphone 32 generates and sends a wireless signal 30 to the notification device 2 that the female individual 22 is wearing at her left wrist.

The female individual 22 has predefined which one of the insert members 4, 4′, 4″, 4′″, 4″″ she wants to be activated upon receiving the signal 30 from the second smartphone 32 (receiving device) of the first individual 20. Furthermore, the individual 22 can define with which colour, light intensity (constant light or blinking light), the insert members 4, 4′, 4″, 4″′, 4″″ are activated. Moreover, the insert members 4, 4′, 4″, 4″′, 4″″ may vibrate.

Accordingly, by looking at the insert members 4, 4′, 4″, 4′″, 4″″ of the notification device 2, the female individual 22 will be provided with information revealing the identity of the sending device 34 and thus the sending individual 20.

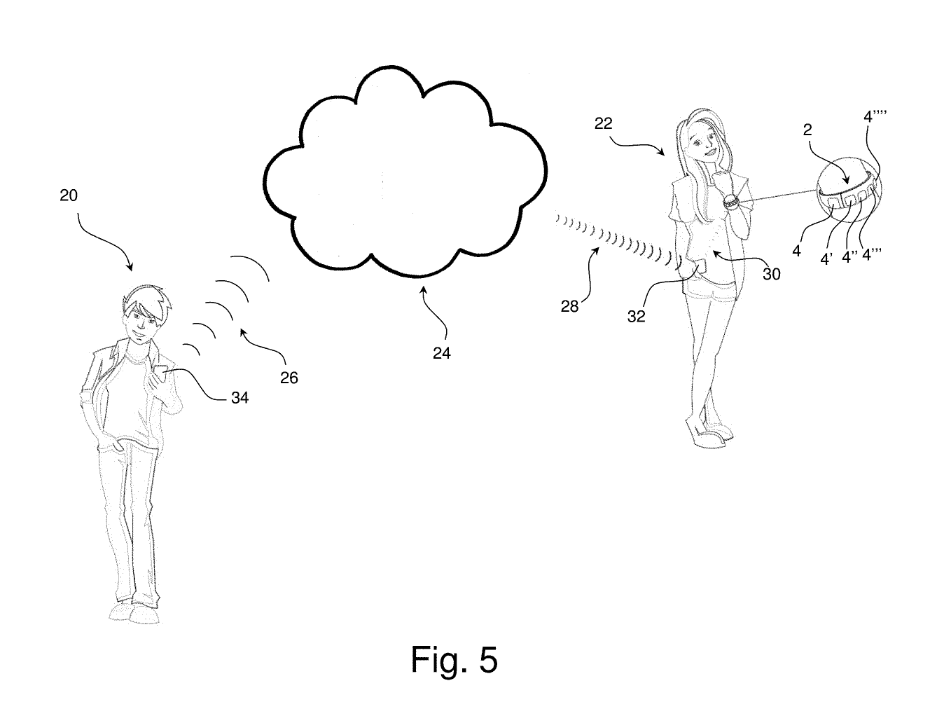

FIG. 5 illustrates another overview of how a notification device 2 according to the invention may be applied to provide communication between a first individual 20 and a second individual 22.

In this case, the first individual 20 is a male person communicating to the female individual 22 by means of his smartphone 34 by means of which the first individual 20 “twinkles” to the second female individual 22.

The first individual 20 communicates with the second individual 22 by means of a first smartphone 34 that functions as a sending device sending a wireless signal 26 via the Internet 24 and a further wireless signal 28 received by a second smartphone 32.

When the second smartphone 32 receives the wireless signal 28, the second smartphone 32 (working as a master device) generates and sends a wireless signal 30 to the notification device 2 (working as a slave device). The female individual 22 is wearing the notification device 2 formed as a bracelet at her left wrist.

The female individual 22 has predefined which one of the insert members 4, 4′, 4″, 4″′, 4″″ that should be allocated to specific individuals and groups. Thus, one of the insert members 4, 4′, 4″, 4′″, 4″″ is configured to be activated when the notification device 2 receives the signal 30 from the second smartphone 32.

Consequently, the female individual 22 can visually detect the identity of the sending device 34 and thus the sending individual 20 by visually inspecting the insert members 4, 4′, 4″, 4″′, 4″″ of the notification device 2.

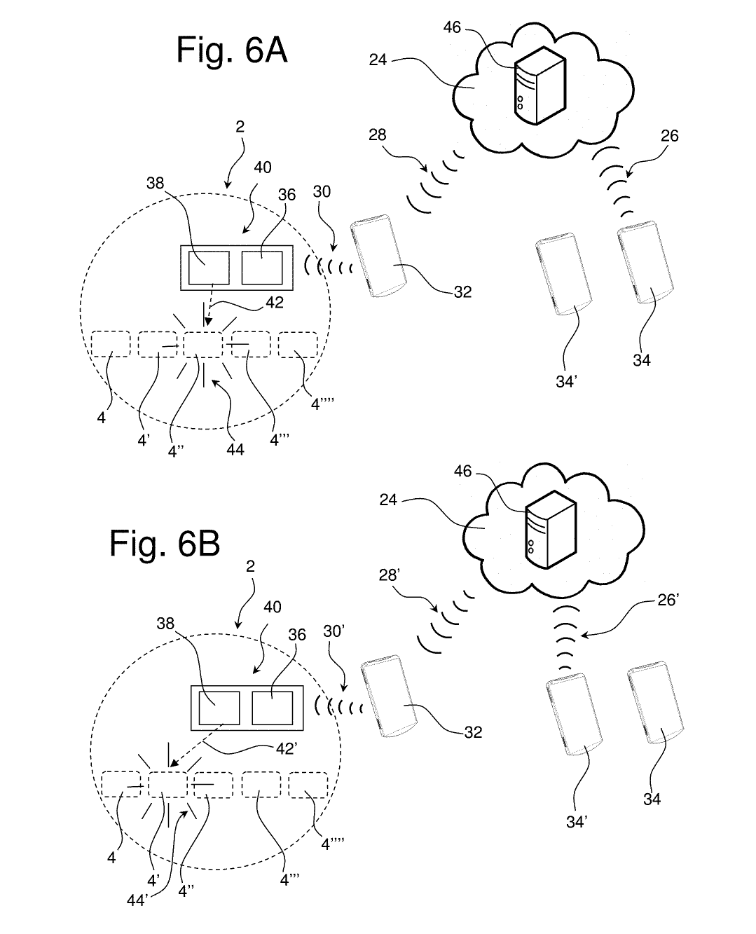

FIG. 6 a) schematically illustrates how a notification device 2 according to the invention can be used to provide the intended communication.

An individual may apply a first smartphone 34 to send a signal 26 via the Internet 24. The signal 26 is sent to a centrally arranged server 46 that generates another signal 28 upon receiving the signal 26 from the first smartphone 34.

The signal 28 is received by another smartphone 32. Upon receiving the signal 28, the other smartphone 32 generates a signal 30 sent to a notification device 2 according to the invention.

The notification device 2 according to the invention comprises a communication unit 40 comprising a receiver unit 36 and a processor 38.

The receiver unit 36 is configured to receive a wireless signal 30. The wireless signal 30 may be coded and comprise information defining the identity of the sending smartphone 34. Upon receiving the wireless signal 30, the receiver unit 36 will provide the received information to the processor 38 that, based on the received information and predefined settings, will determine which of insert members 4, 4′, 4″, 4″′, 4″″ should be activated or which of the signalling members 12, 12′, 12″, 12′″ arranged under the insert members 4, 4′, 4″, 4″′, 4″″ should be activated. The receiver unit 36 may also include a transmitter unit configured to provide wireless communication with a master unit 32 and/or an external receiver 34, 34′ e.g. through the Internet 24.

In one embodiment of the invention, the signalling member 14 arranged below the insert member 4 may be configured to initiate the step of sending a signal to a master unit 32 and/or to an external receiver 34, 34′.

Hereby, the user may reply to a notification simply by activating the signalling member 14 by pushing the insert member 4.

When a signal 30 is received by the communication unit 40, the communication unit 40 sends a signal 42 that determines which of the signalling members 12, 12′, 12″, 12″′ arranged under the insert members 4, 4′, 4″, 4′″, 4″″ should be activated. It is important to notice that the communication unit 40 may send a signal 42 that activates one or more of the signalling members 12, 12′, 12″, 12″′ or the insert members 4, 4′, 4″, 4″′, 4″″ as long as the activation pattern is predefined and allows the user to recognise the identity of the sender based on the activation pattern.

In FIG. 6a), the insert member 4″ is activated. Hereby a light signal 44 is generated. Thus, a LED placed under the 4″ lights up or flashes.

FIG. 6b) schematically illustrates another example of how a notification device 2 according to the invention can be used to provide the intended communication.

Another individual or a group may apply a smartphone 34′ to send a signal 26′ via the Internet 24. The signal 26′ may be generated by means of a software application installed on a server 46 connected to the Internet 24. The server 46 generates a signal 28′ and sends the signal 28′ to a receiving smartphone 32. Upon receiving the signal 28′, the smartphone 32 generates a signal 30′ that is received by a notification device 2 according to the invention.

The notification device 2 corresponds to the one illustrated in FIG. 6a), and thus comprises a communication unit 40 comprising a receiver unit 36 and a processor 38.

The receiver unit 36 receives the wireless signal 30′ and provides the received information to the processor 38. The processor 38 determines which of insert members 4, 4′, 4″, 4″′, 4″″ should be activated or which of the signalling members 12, 12′, 12″, 12″′ arranged under the insert members 4, 4′, 4″, 4″′, 4″″ should be activated. This determination is based on the received information and predefined settings of the notification device 2. It may be an advantage that these settings may be set through communication with the server 46.

In FIG. 6b), the insert member 4′ is activated on the basis of a signal 42′ sent from the communication unit 40 to the insert member 4′. Accordingly, a light signal 44′ is generated and a LED placed under the insert member 4′ will start to light or flash.

A smartphone application may be installed in the receiving smartphone 32 and in the sending smartphones 34, 34′. The smartphone application determines which of the insert members 4, 4′, 4″, 4″′, 4″″ should be activated upon receiving an activation signal 30, 30′.

FIG. 7a) schematically illustrates an alternative of how a notification device 2 according to the invention can be used to provide the intended communication. FIG. 7a) almost corresponds to FIG. 6a). The only difference is that the communication unit 40 sends a more complex signal 42 to the signalling members 12, 12′, 12″, 12″′ arranged under the in- sert members 4, 4′, 4″, 4′″, 4″″. The communication unit 40 sends a signal 42 that activates two of the signalling members 12′, 12″′ arranged below the 4″, 4″″. The signalling members 12′, 12′″ send out a signal 44. Hereby the user is provided with a recognisable pattern that uniquely reveals the identity of the sender. It is important to notice that the signalling members may generate an audio signal.

FIG. 7 b) schematically illustrates another example of how a notification device 2 according to the invention can be used to provide the intended communication. FIG. 7b) essentially corresponds to FIG. 7b).However, the communication unit 40 sends a signal 42′ that activates three of the signalling members 12, 12″, 12″′ arranged below the 4′, 4′″, 4″″. The signalling members 12′, 12″′ send out a signal 44′ that makes it possible for the user to recognise, in order to uniquely disclose, the identity of the sender.

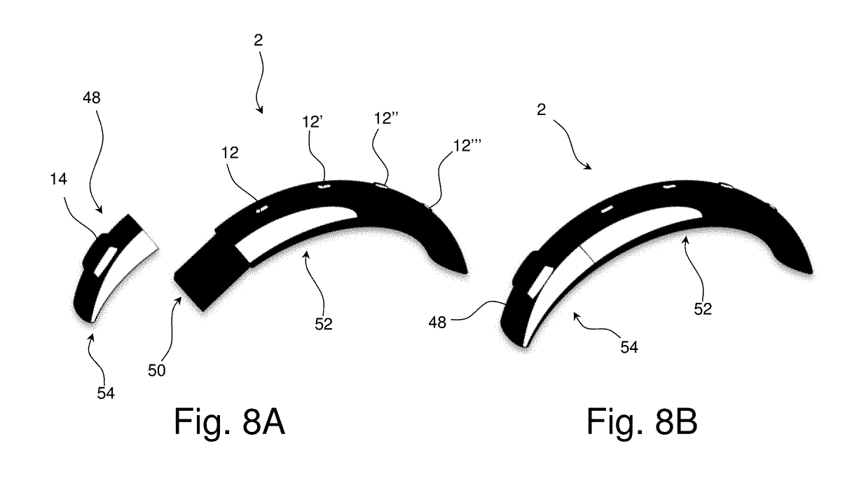

FIG. 8a) illustrates a section of a notification device 2 according to the invention. The notification device 2 is a bracelet, however, only the uppermost section of the bracelet 2 is shown.

The bracelet 2 comprises a first member 52 and a second member 54. The first member 52 comprises a battery electrically connected to a charging plug member 50. The second member 54 is shaped as a cap 48 configured to be received by the charging plug member 50. The second member 54 comprises a signalling member 14 configured to signal when a signal (by any sender) is received by the bracelet 2.

The charging plug member 50 is a Universal Serial Bus (USB) plug. The first member 52 comprises four signalling members 12, 12′, 12″, 12′″ configured to signal (light) when a predefined individual or group sends a signal to the bracelet 2.

FIG. 8b) illustrates the bracelet 2 shown in FIG. 8a) in a state in which the cap 48 of the second member 54 has been detachably attached to the charging plug member 50 of the first member 52.

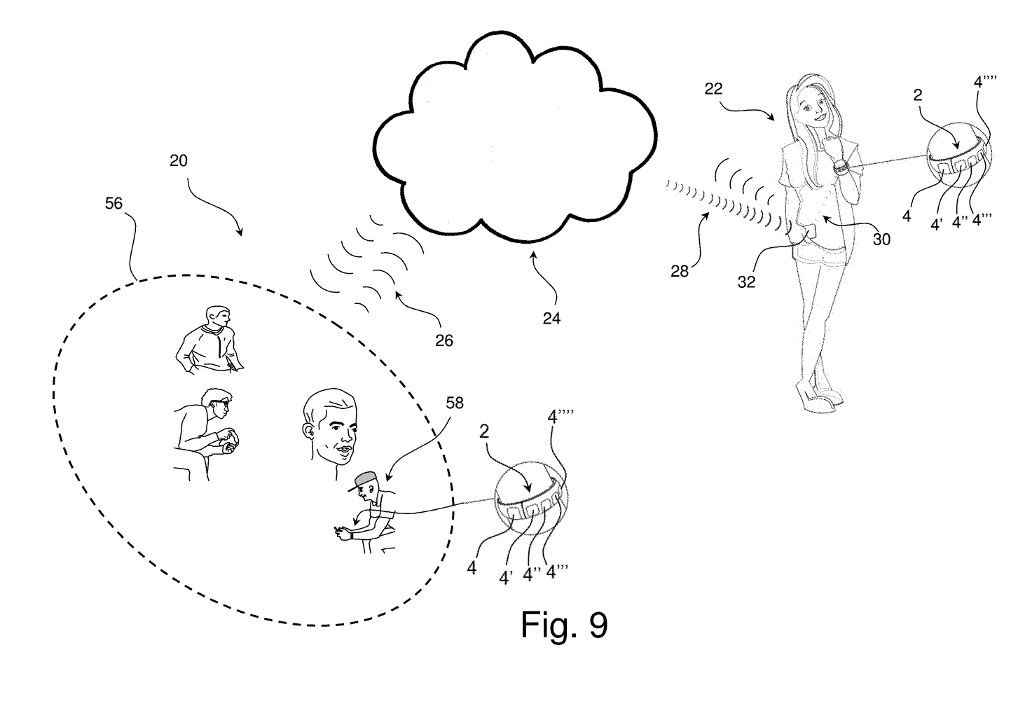

FIG. 9 illustrates an overview of how a notification device 2 according to the invention may be applied to provide communication between a group 56 of individuals 58 and a single individual 22. The female individual 22 is wearing the notification device 2 formed as a bracelet at her left wrist and she can receive notification.

In this case, the group 56 (a music band) of individuals 58 (musicians) comprises a plurality of different members who are communicating with a female individual 22 by means of smartphones (not shown). Each individual 58 of the group 56 has a smartphone (not shown) configured to provide communication with the individual 22. The individual 22 receives a “twinkle” from group 56 by means of her smartphone 32.

When the individual 22 responds by sending a twinkle to the group 56 like illustrated in FIG. 9, the smartphone 32 functions as a sending device sending a wireless signal 28 via the Internet 24 and a further wireless signal 26 received by a smartphone of each of the individuals 58 of the group 56.

When smartphones of the individuals 58 of the group 56 receive the wireless signal 26, the smartphones of the individuals (working as master devices) generate and send wireless signals to the notification devices 2 (working as slave devices) of the individuals 58.

Each of the individuals 58 have predefined which one of the insert members that should be allocated to specific individuals and groups. Thus, one of the insert members 4, 4′, 4″, 4″′, 4″″ is configured to be activated when the notification device 2 receives signals from the connected smartphone (not shown).

Consequently, the individuals 58 can visually detect the identity of the sending device 32 and thus the sending individual 22 by visually inspecting the insert members 4, 4′, 4″, 4″′, 4″″ of the notification device 2.

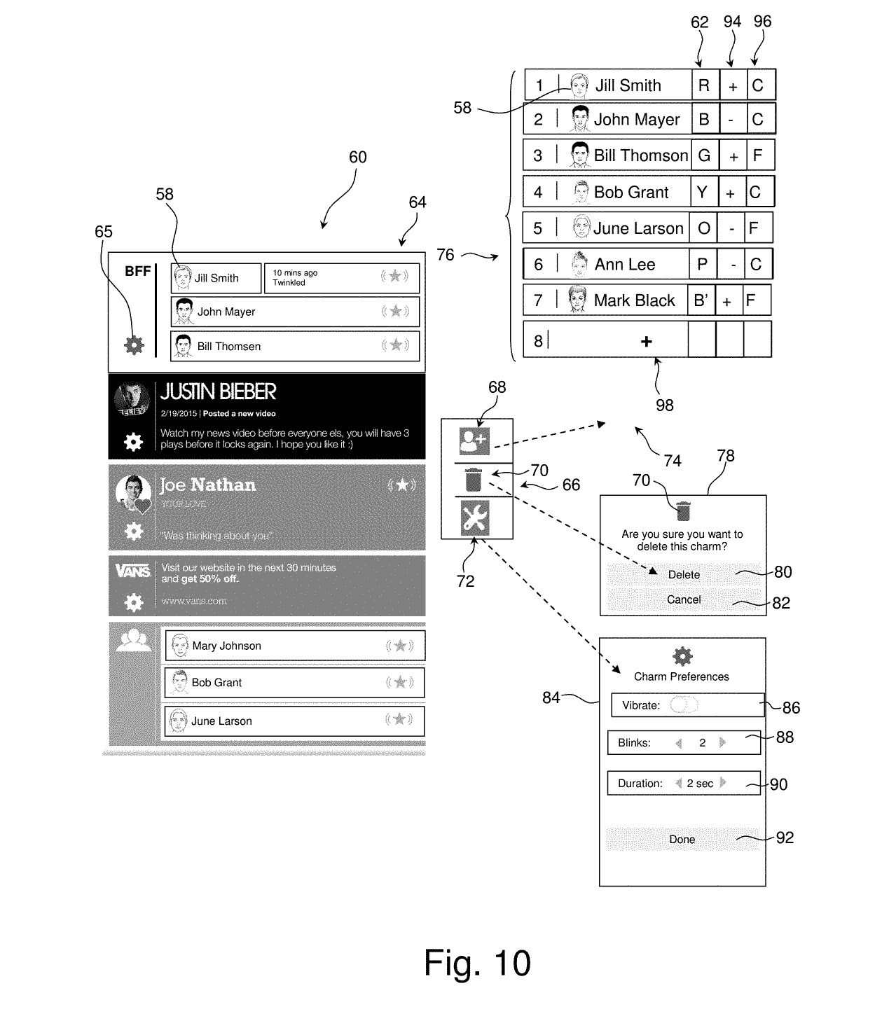

FIG. 10 illustrates a user interface 60 according to one embodiment of the method according to the invention. The user interface 60 shows the recent incoming notifications. It can be seen that one individual 58, named Jill Smith, categorised in the field BFF (best friends forever) together with John Mayer and Bill Thomson have twinkled recently. The user interface 60 also shows that recently Justin Bieber has posted a video, that Joe Nathan has “twinkled” the user and that VANS has posted a message. In the lower area of the user interface 60, additional contacts of the user are listed.

If the user presses the “Setting” icon 65, the tool box 66 shows up. The tool box 66 comprises an “Add individual or group” icon 68 provided in the upper portion of the tool box 66. The tool box 66 comprises an “Add individual or group” icon 68 provided in the upper portion of the tool box 66. The tool box 66 comprises a “Delete” icon 70 provided below the upper portion of the tool box 66 and a “Preferences” icon 72 provided in the bottom portion of the tool box 66.

If the user presses the “Add individual or group” icon 68 shows up. This view, the user can add an individual 74 (named Mark Black). The colour column 62 indicates the selected colour of the LED signal on the associated bracelet of the contacts 76. R refers to red, B refers to blue, G refers to green, Y refers to yellow, O refers to orange, prefers to purple and B′ refers to brown. A vibration column 94 (indicating if vibration is activated or not) is provided next to the colour column 62. In the vibration column 94 +symbols indicate “activated”, whereas −symbols indicate “not activated”. A light intensity column 96 (indicating if the light has constant intensity marked with “C”, or flashing intensity marked with “F”) is provided next to the colour column 62.

The lowest row (row number 8) is empty. Therefore, the user may add an individual into this box. The individual may be given a net colour and likewise the vibration and light intensity can be defined by the user. All members 76 are allocated to the same charm on the bracelet; however, the light colour and intensity as well as the vibration signal may be selected by using an application as illustrated in FIG. 10.

If the user presses the “Delete” icon 70, a view of a box 78 shows up. The user can delete the contacts (individuals 58, 74 and groups) from a charm of a notification device according to the invention by pressing the delete icon 70. Deletion is completed when the user confirms the action by pressing the “Delete” button 80. The user can cancel the action by pressing the “Cancel” button 82 below the “Delete” button 80.

If the user presses the “Preferences” icon 72, a view of a preference box 84 shows up. The user can change the preferences including defining if the notification should vibrate. This is done by setting the vibration box 86. The user can choose the number of blinks that should be emitted by the corresponding charm or charms of the notification device according to the invention. This is done by setting the number in the “Blinks” box 88. The duration or the blinks and or vibrations can be set in the “Duration” box 90. When the user has finished the setting process, the “Done” box 92 can be pushed.

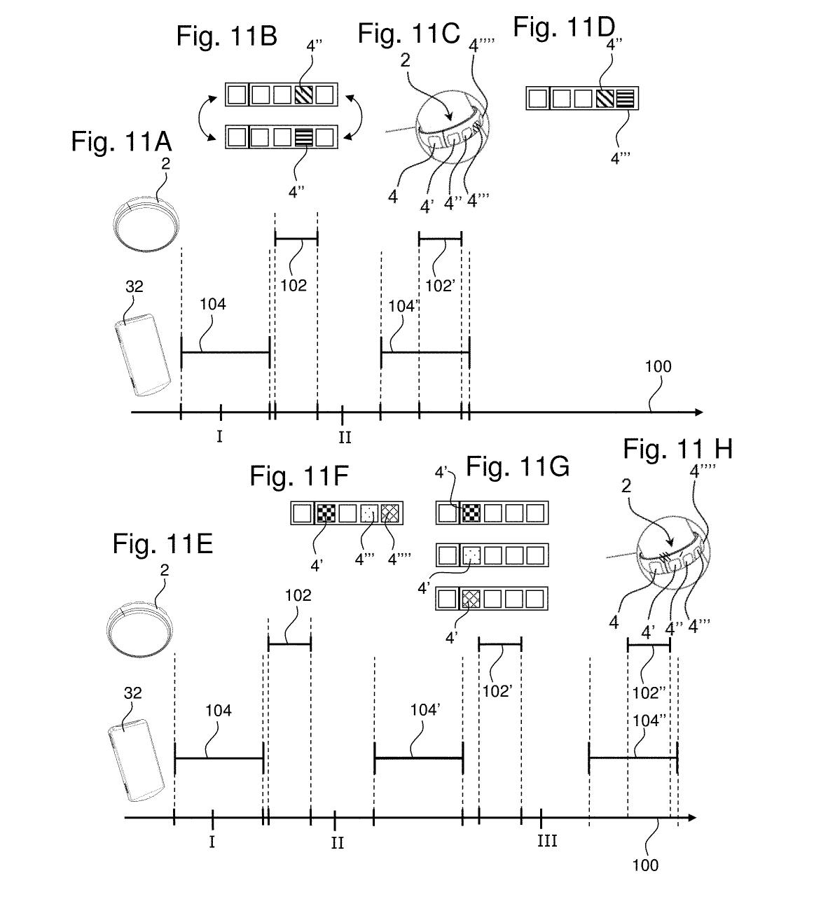

FIG. 11a) illustrates a schematic view of a mobile phone 32 and a notification device 2 according to the invention. The mobile phone 32 receives a first notification I and a second notification II (e.g. twinkles) from individuals or groups. The mobile phone sends information to the notification device 2 in the first time period 104 and in a second time period 104′ shown above a time line 100. Likewise, the notification device 2 receives information in a first time period 102 and in a second time period 102′.

The notification device 2 receives the first notification I and the second notification II in the second time period 102′, in which the mobile phone sends information and the notification device receives information. FIG. 10 illustrates an example in which the same insert member (charm) 4″ is allocated to notify the user about twinkles from the individual sending the first notification I and the individual sending the second notification II. In this example, the notification device flashes in two different colours in turns. The first colour is associated to the first individual sending the first notification I, whereas the second colour is associated to the second individual sending the second notification II.

FIG. 11c) illustrates the notification device 2 schematically shown in FIG. 11b). FIG. 11d) illustrates an example in which two different insert members (charms) 4″, 4″′ are allocated to notify the user about twinkles from the individual sending the first notification I and the individual sending the second notification II. In this example, the two insert members 4″, 4′″ light up e.g. in two different colours (if the settings define so). The user of the notification is informed about the two notifications because the position of the insert members 4″, 4′″ is part of the information.

FIG. 11e) illustrates a schematic view of a mobile phone 32 and a notification device 2 according to the invention. The mobile phone 32 receives a first notification I, a second notification II and a third notification III (e.g. twinkles) from individuals or groups. The mobile phone sends information to the notification device 2 in the first time period 104, a second time period 104′ and in a third time period 104″ shown above a time line 100. Likewise, the notification device 2 receives information in a first time period 102, a second time period 102′ and in a third time period 102″.

The notification device 2 receives the first notification I, the second notification II and the third notification III. The mobile phone 32 sends information to the notification device 2 that receives information in the time period 102″.

FIG. 11f) illustrates an example in which the same insert member 4″ is allocated to notify the user about twinkles from the three individuals sending the first notification I, the second notification II and the third notification III. In this example, three insert members 4′, 4″′, 4″″ light up at the same time. The notification device is configured to show several notifications (from different individuals or groups) at the same time.

FIG. 11h) illustrates the notification device 2 schematically shown in FIG. 11g). FIG. 11g) illustrates an example in which the same insert member 4′ is allocated to notify the user about twinkles from the three individuals sending the first notification I, the second notification II and the third notification III. In this example, the notification device 2 flashes in three different colours in turns. The first colour is associated to the first individual sending the first notification I, the third colour is associated to the second individual sending the second notification II, whereas the third colour is associated to the third individual sending the third notification III.

1. A notification device comprising:
a communication unit configured to wirelessly communicate with a master unit;
the notification device comprising a plurality of signalling members and/or insert members configured to provide a signal upon receiving a signal from the master unit;
wherein the notification device comprises a plurality of different signalling members and/or insert members arranged at a plurality of different positions on the notification device and a communication unit configured to generate a unique and predefined position specific signal for each predefined individuals and/or group(s) when the master unit receives signals from one or more different predefined individuals and/or group(s).

2. The notification device of claim 1 wherein the communication unit is configured to generate several unique and predefined position specific signals for several predefined individuals and/or group(s) simultaneously, when the master unit simultaneously receives several signals from several different predefined individuals and/or group(s).

3. The notification device of claim 1 wherein the insert members and/or signalling members are detachably attached to the notification device.

4. The notification device of claim 1 wherein the insert members and/or signalling members are movably attached to the notification device.

5. The notification device of claim 4 wherein one of the signalling members and/or the insert members is configured to signal upon receiving a receiving signal from any predefined sender and that a plurality of the remaining insert members and/or signalling members are configured to signal only upon receiving a predefined receiving signal from one or more specific and predefined senders.

6. The notification device of claim 1 wherein the notification device comprises a first member and a second member and that the first member comprises a battery electrically connected to a charging plug member configured to be electrically connected to external charging means.

7. The notification device of claim 5 wherein the second member comprises a cap configured to be received by the charging plug member.

8. The notification device of claim 1 wherein the notification device is a bracelet.

9. The notification device of claim 1 wherein the notification device comprises means for sending a signal to a master unit and/or to an external receiver.

10. A system comprising the notification device of claim 1 and an electrical device comprising storage means configured to store one or more software applications and means for being accessed with a sending device and means for generating a signal upon receiving a signal from the sending device, where the signal is receivable by the master unit.

11. The system of claim 10, wherein the system comprises a master device configured to communicate with the notification device and to receive a signal from an external device.

12. The system of claim 10, wherein the system comprises a setting member for setting which of the different signalling members and/or insert members are allocated to the signal when the master unit, receives signals from specific different predefined individuals and/or group(s).

13. A method for informing a user of incoming notifications by means of a notification device comprising a communication unit configured to wirelessly communicate with a master unit, which notification device comprises a plurality of signalling members and/or insert members arranged at a plurality of different positions on the notification device and being configured to provide a signal upon receiving a signal from the master unit, wherein the method comprises the step of generating a unique and predefined position specific signal for each predefined individual and/or group(s) when the master unit receives signals from one or more different predefined individuals and/or group(s).

14. The method of claim 13, further comprising the step of generating several unique and predefined position specific signals for several predefined individuals and/or group(s) simultaneously, when the master unit simultaneously receives several signals from several different predefined individuals and/or group(s).

15. The method of claim 13, further comprising the step of setting which of the different signalling members and/or insert members are to be allocated to the signal when the master unit receives signals form specific different predefined individuals and/or group(s).
